(19) United States
(12) Patent Application Publication
(10) Pub. No.: US 2025/0039923 A1
(43) Pub. Date: Jan. 30, 2025

(54) MULTI-SLOT UPLINK TRANSMISSION OCCASIONS DURING NETWORK DISCONTINUOUS RECEPTION CYCLES

(71) Applicant: QUALCOMM Incorporated, San Diego, CA (US)

(72) Inventors: Ahmed Attia ABOTABL, San Diego, CA (US); Diana MAAMARI, San Diego, CA (US)

(21) Appl. No.: 18/226,756

(22) Filed: Jul. 26, 2023

(51) Int. Cl. H04W 74/08

(52) U.S. Cl. CPC H04W 74/08

(57) ABSTRACT

Certain aspects of the present disclosure provide techniques for wireless communications by an apparatus. A method includes receiving a first indication of a first plurality of uplink transmission occasions, the first plurality of uplink transmission occasions to occur over a first plurality of time periods; receiving a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and refraining from transmitting in the first one or more uplink transmission occasions.

### INTRODUCTION

### Field of the Disclosure

Aspects of the present disclosure relate to wireless communications, and more particularly, to techniques for multi-slot uplink transmission communication during network discontinuous reception cycles.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving a first indication of a first plurality of uplink transmission occasions, the first plurality of uplink transmission occasions to occur over a first plurality of time periods; receiving a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and refraining from transmitting in the first one or more uplink transmission occasions.

Another aspect provides a method for wireless communications by an apparatus. The method includes sending, to a user equipment (UE), a first indication of a first plurality of uplink transmission occasions, the first plurality of uplink transmission occasions to occur over a first plurality of time periods; sending, to the UE, a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and refraining from receiving from the UE in the first one or more uplink transmission occasions.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 illustrates an example timeline where at least part of an uplink transmission occasion of a UE occurs during a non-active duration of a network entity.

FIG. 6 depicts a method for wireless communications.

FIG. 7 depicts another method for wireless communications.

FIG. 8 depicts aspects of an example communications device.

FIG. 9 depicts aspects of an example communications device.

### DETAILED DESCRIPTION

Aspects of the present disclosure provide apparatuses, methods, processing systems, and computer-readable mediums for multi-slot uplink transmission communication during network discontinuous reception (DRX) cycles.

A network entity (e.g., a base station (BS)) may be configured to communicate (e.g., transmit, send, receive, obtain, monitor, etc.) according to a communication cycle configuration that generally defines a time period, referred to as an active duration (also referred to as an active time or active time period), designated for the network entity to communicate signals, and a non-active duration (also referred to as a non-active time, non-active time period, an inactive duration, an inactive time, or an inactive time period), designated for the network entity to not communicate signals. The communication cycle may occur periodically. Accordingly, the BS may be configured to periodically cycle between an active duration and a non-active duration according to a configuration of the communication cycle.

One type of communication cycle is a DRX cycle, wherein during the active duration, the network entity actively receives and/or monitors for signals (e.g., all types of signals). During the non-active duration, the network entity may not receive and/or monitor for signals (e.g., all types of signals) or may receive and/or monitor for only certain types of signals (e.g., uplink transmissions such as transmissions in physical uplink shared channel (PUSCH) occasions from a user equipment (UE)).

Another type of communication cycle is a discontinuous transmission (DTX) cycle, wherein during the active duration, the network entity actively transmits signals (e.g., all types of signals). During the non-active duration, the network entity may not transmit signals (e.g., all types of signals) or may transmit only certain types of signals. Where the network entity is configured with a DRX cycle configuration and a DTX cycle configuration, the DRX and DTX cycles may be aligned (i.e., the active duration of the DRX and DTX cycle align in time such that they occur for both at the same time and the non-active duration of the DRX and DTX cycle align in time such that they occur for both at the same time) or may not be aligned.

Such communication cycles can provide power savings at the network entity, as the network entity may operate using reduced power (e.g., sleep) during non-active durations as compared to active durations. Such communication cycles can further provide power savings for devices (e.g., UEs) that communicate with the network entity, such as if they similarly operate according to the same communication cycles.

In certain aspects, a UE is configured to transmit uplink transmissions to the network entity across multiple time periods (e.g., slots). For example, the UE may be configured with a plurality of uplink transmission occasions (e.g., a time period configured for the UE to transmit in the uplink, such as PUSCH occasions) during which the UE is configured to transmit (e.g., transmit data, control information, feedback, etc.) to the network entity. For example, the UE may be configured with the plurality of uplink transmission occasions by a configured grant (CG) or a dynamic grant (DG). For example, the UE may be configured with a burst of transmissions by a CG. In another example, the UE may be configured to transmit a transport block over multiple slots (TBoMS), such that the UE is configured with a plurality of uplink transmission occasions for transmission of the transport block. In yet another example, the UE may be configured to perform PUSCH repetition, such as Type A or Type B, over multiple slots, such as in multiple PUSCH occasions.

In some cases, where the network entity is operating according to a DRX cycle configuration, at least part of an uplink transmission occasion of the UE may occur during a non-active duration of the network entity. Aspects discussed herein describe techniques for handling the scenario where one or more uplink transmission occasions of a plurality of uplink transmission occasions at least partly occur during one or more non-active durations of the network entity. In one example, multiple uplink transmission occasions of the one or more uplink transmission occasions may at least partly occur during one non-active duration. In another example, all of the one or more uplink transmission occasions may at least partly occur during one non-active duration. In another example, some but not all of the one or more uplink transmission occasions may at least partly occur during one non-active duration, such that not all of the one or more uplink transmission occasions at least partly occur during the same non-active duration. In one example, an uplink transmission occasion partly occurring during a non-active duration may include the entire uplink transmission occasion occurring during the duration of a non-active duration. In another example, an uplink transmission occasion partly occurring during a non-active duration may include only a portion of the duration of the uplink transmission occasion occurring during the duration of a non-active duration and another portion of the uplink transmission occasion occurring during the duration of an active duration.

In certain aspects, when one or more uplink transmission occasions of a plurality of uplink transmission occasions at least partly occur during one or more non-active durations of the network entity, the UE refrains from transmitting in any of the plurality of uplink transmission occasions. This may provide the technical effect of reducing power consumption at the network entity during the non-active duration, as the network entity does not need to monitor for transmissions from the UE during the one or more uplink transmission occasions.

In certain aspects, when one or more uplink transmission occasions of a plurality of uplink transmission occasions at least partly occur during one or more non-active durations of the network entity, the UE still transmits in all of the plurality of uplink transmission occasions. This may provide the technical effect of reducing latency in transmitting by the UE, by allowing communication even during the non-active durations. This may also provide the technical effect of allowing coding of signals over a greater number of resources (e.g., time-frequency resources), providing additional reliability for communications.

In certain aspects, when one or more uplink transmission occasions of a plurality of uplink transmission occasions at least partly occur during one or more non-active durations of the network entity, the UE refrains from transmitting in the one or more uplink transmission occasions, but still transmits in the other uplink transmission occasions of the plurality of uplink transmission occasions. This may provide the technical effect of reducing power consumption at the network entity during the non-active duration, as the network entity does not need to monitor for transmissions from the UE during the one or more uplink transmission occasions. This may also provide the technical effect of reducing latency in transmitting by the UE, by allowing communication over those of the plurality of uplink transmission occasions that do not occur during one or more non-active durations.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

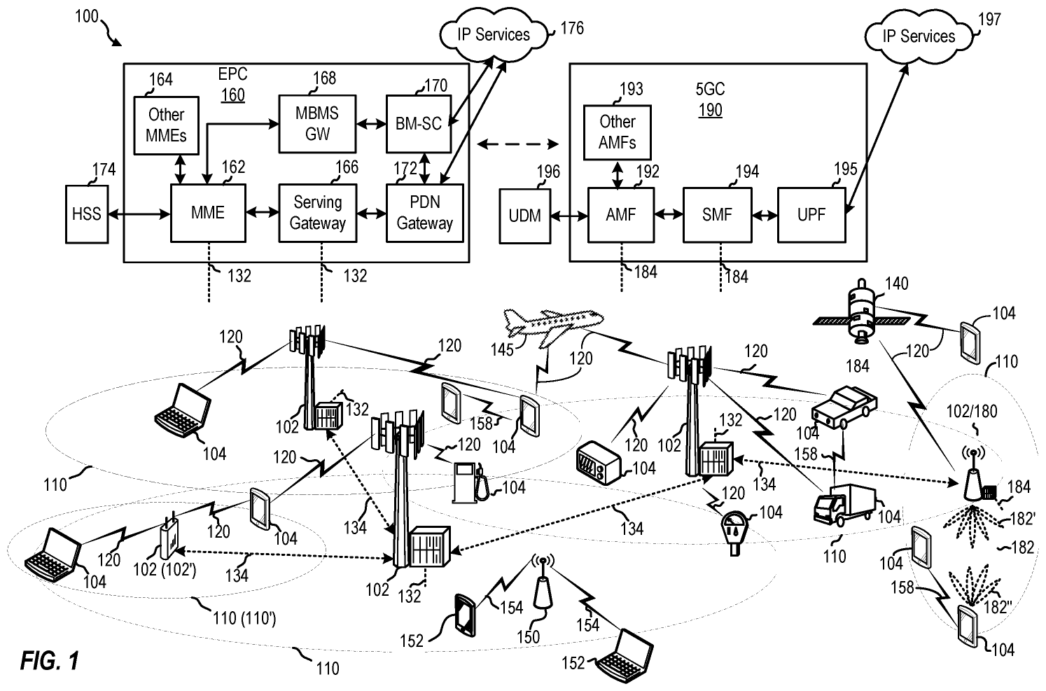

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

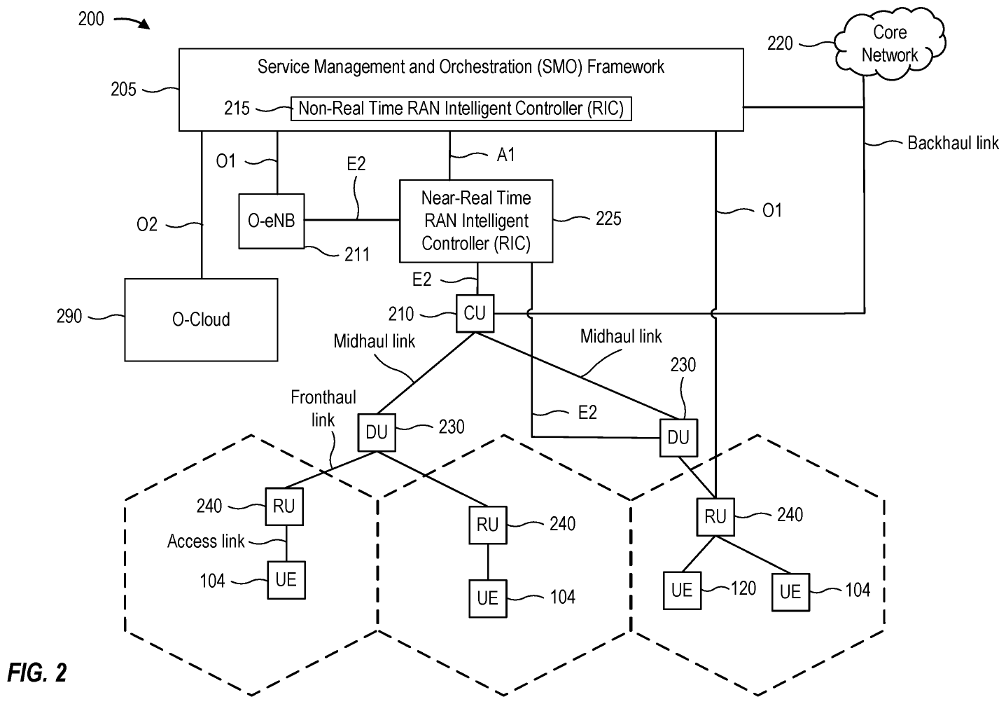

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

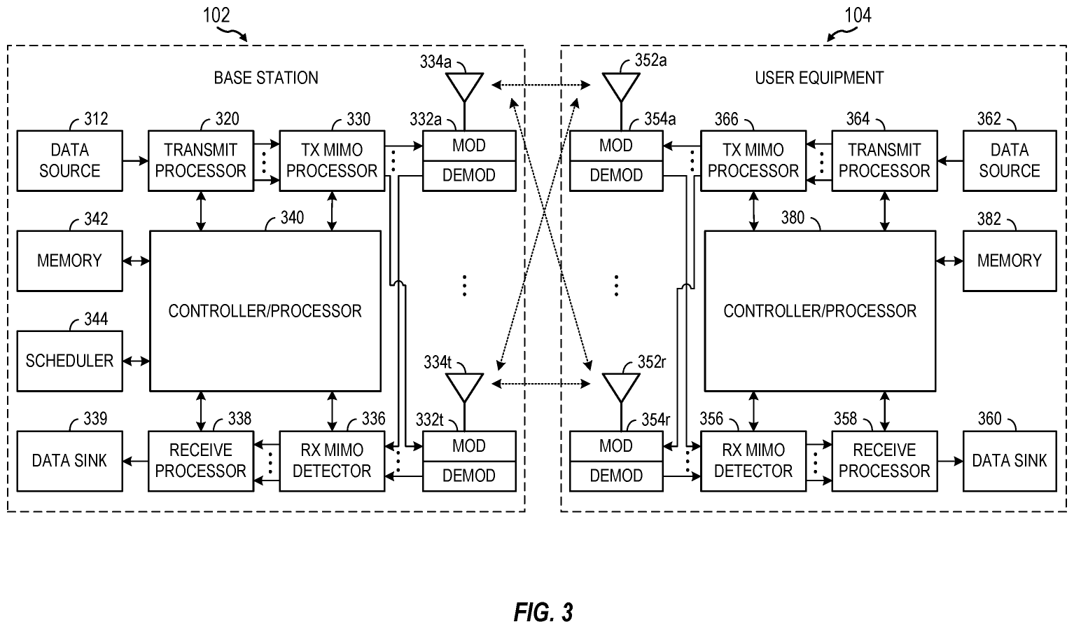

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

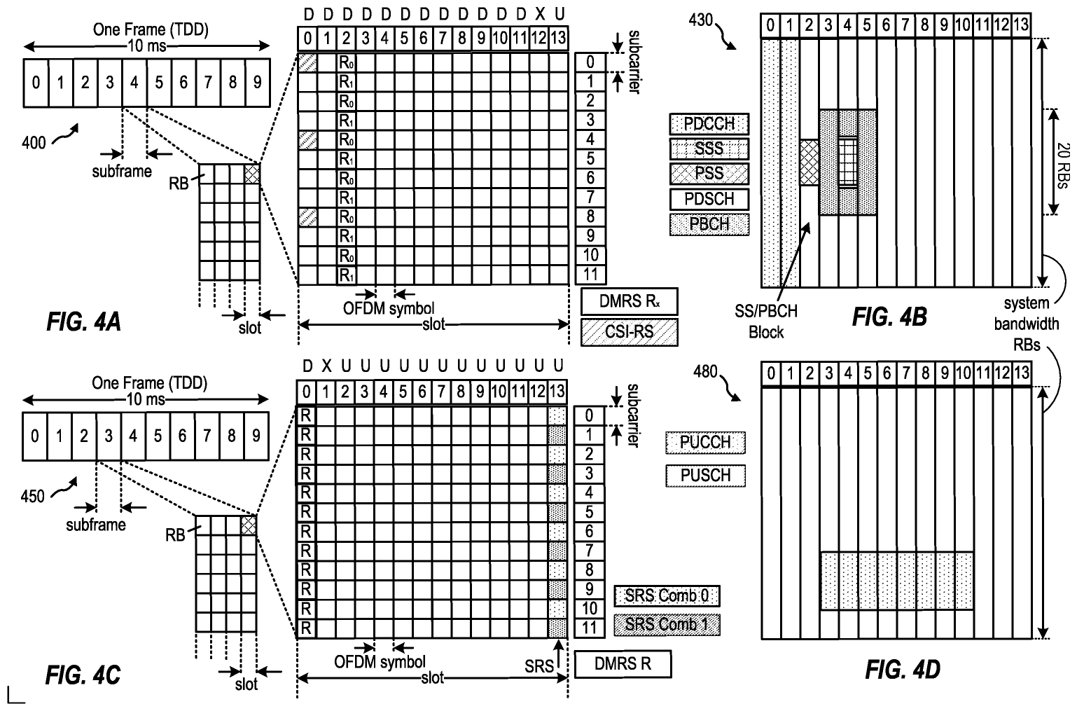

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 24^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Configured Grant

As discussed, one way that a UE may be configured with a plurality of uplink transmission occasions is by configured grant (CG), where the CG is an example of an indication of a plurality of uplink transmission occasions, the plurality of uplink transmission occasions to occur over a plurality of time periods. In certain aspects, a network entity (e.g., BS) is configured to send a configured grant to a UE, the configured grant indicating a plurality of uplink transmission occasions (e.g., PUSCH occasions) for the UE to transmit uplink transmissions (PUSCH transmissions), such as to the network entity. The CG may be sent by the network entity in a radio resource control (RRC) message and/or downlink control information (DCI). A configured grant may configure a periodically recurring plurality of uplink transmission occasions over a recurring plurality of time periods. In certain aspects, when referring herein to one or more uplink transmission occasions of a plurality of uplink transmission occasions at least partly occurring during one or more non-active durations, the plurality of uplink transmission occasions refers to a single occurrence of resources granted by configured grant, as in a single occurrence of the periodically recurring set of resources configured by configured grant. In certain aspects, the CG indicates a number of time periods (e.g., slots) allocated to the UE per periodic occurrence. In certain aspects, the CG indicates a number of uplink transmission occasions per slot. The CG may additionally indicate other information. Overall, the CG may identify when in time (e.g., and where in frequency) the plurality of uplink transmission occasions occur over the plurality of time periods (e.g., slots).

### Aspects Related to Dynamic Grant

As discussed, another way that a UE may be configured with a plurality of uplink transmission occasions is by dynamic grant (DG), where the DG is an example of an indication of a plurality of uplink transmission occasions, the plurality of uplink transmission occasions to occur over a plurality of time periods. In certain aspects, a network entity (e.g., BS) is configured to send a dynamic grant to a UE, the dynamic grant indicating a plurality of uplink transmission occasions (e.g., PUSCH occasions) for the UE to transmit uplink transmissions (PUSCH transmissions), such as to the network entity. The DG may be sent by the network entity in DCI. The DG may identify when in time (e.g., and where in frequency) the plurality of uplink transmission occasions occur over the plurality of time periods (e.g., slots). In certain aspects, when referring herein to one or more uplink transmission occasions of a plurality of uplink transmission occasions at least partly occurring during one or more non-active durations, the plurality of uplink transmission occasions refers to a single occurrence of dynamic grant.

### Aspects Related to PUSCH Repetition

In certain aspects, a UE is configured to perform PUSCH repetition. In particular, the UE is configured to transmit repetitions of a transport block in PUSCH repetitions, such as to a network entity, such as a BS. The UE may be configured to perform PUSCH repetition for a PUSCH transmission scheduled either by DG or CG in DCI. Each PUSCH repetition may span one or more symbols. There may be different types of PUSCH repetition, such as Type A and Type B. In certain aspects, when referring herein to one or more uplink transmission occasions of a plurality of uplink transmission occasions at least partly occurring during one or more non-active durations, the plurality of uplink transmission occasions refers to PUSCH repetitions for a single transport block.

In PUSCH repetition Type A, one PUSCH repetition occurs per slot, and the PUSCH repetitions occur in consecutive slots. In particular, the configuration parameters for PUSCH repetition Type A include K, L, and S. K is a number of nominal repetitions of PUSCH. L is the nominal length in number of symbols of each nominal repetition of PUSCH. S is the starting symbol within a slot for each nominal repetition of PUSCH. A repetition may be referred to as a “nominal” repetition because PUSCH may not actually be transmitted in such a nominal repetition. In certain aspects, a nominal repetition of PUSCH may be considered an uplink transmission occasion. In certain aspects, S and L are given by a parameter referred to as a starting length and indicator vector (SLIV). A SLIV may be indicated by a row index in a time domain resource allocation (TDRA) signaled in DCI for a scheduled PUSCH. In certain aspects, K is also signaled in the DCI. For example, a network entity may send a DCI indicating the configuration parameters for PUSCH repetition Type A to UE. The DCI may be an example of an indication of a plurality of uplink transmission occasions, the plurality of uplink transmission occasions to occur over a plurality of time periods.

In PUSCH repetition Type B, PUSCH repetitions occur in consecutive symbols. In particular, the configuration parameters for PUSCH repetition Type B also include K, L, and S. K is the number of nominal repetitions of PUSCH. L is the nominal length in number of symbols of each nominal repetition of PUSCH. S is the starting symbol within a slot for the first nominal repetition of PUSCH. Further, all the nominal repetitions of PUSCH are in consecutive symbols starting from the symbol S. In certain aspects, the configuration parameters for PUSCH repetition Type B may be signaled from a network entity to a UE in the same manner as the configuration parameters for PUSCH repetition Type A. The signaling may be an example of an indication of a plurality of uplink transmission occasions, the plurality of uplink transmission occasions to occur over a plurality of time periods.

The K nominal repetitions of PUSCH may be referred to as “nominal” because PUSCH may not actually be transmitted by the UE in each occurrence of a nominal repetition of PUSCH, or the nominal repetition may be divided, also referred to as fragmented, into a plurality of PUSCH repetitions that are transmitted. Accordingly, the nominal repetitions of PUSCH may be considered “intended” repetitions of PUSCH. Each PUSCH repetition that is transmitted by the UE may be referred to as an actual repetition or actual PUSCH repetition due to such repetition actually being transmitted. The nominal length L of a nominal PUSCH repetition is referred to as “nominal” because PUSCH may be actually transmitted in a different number of (e.g., fewer) symbols.

### Aspects Related to Communication of a Transport Block Over Multiple Slots (TBOMS)

As discussed, another way that a UE may be configured with a transmission spanning multiple slots is by being configured to transmit a TBoMS, such that the UE is configured with a number of slots over which a PUSCH transmission would be granted. TBoMS differs from PUSCH repetition type A in that in PUSCH repetition type A, the multiple repetitions of a transport block are transmitted in multiple slots, while in TBoMS one transport block is encoded across multiple slots and transmitted across the multiple slots. In certain aspects, a network entity is configured to send DCI (e.g., DCI format 0_1 or 0_2) to a UE, configuring the UE to transmit a transport block over multiple slots. The DCI may indicate a number of slots K (unrelated to the K number of nominal PUSCH repetitions) over which to transmit the transport block. For example, the DCI may include an index value for a time domain resource allocation (TDRA) table configured at the UE (e.g., by the network entity using RRC signaling). The index value may index to an entry of the TDRA table, the entry indicating K (e.g., and other information). The DCI may be an example of an indication of a plurality of uplink transmission occasions, the plurality of uplink transmission occasions to occur over a plurality of time periods. In certain aspects, when referring herein to one or more uplink transmission occasions of a plurality of uplink transmission occasions at least partly occurring during one or more non-active durations, the plurality of uplink transmission occasions refers to the plurality of uplink transmission occasions for a TBoMS (e.g., each uplink transmission occasion being a slot over which to transmit the transport block, such as corresponding to one redundancy version)

In certain aspects, to perform TBoMS, the UE maintains a circular buffer to determine which bits of a transport block to transmit on which slots allocated for the TBoMS, such as based on the number of slots K over which to transmit the transport block. For example, the UE determines a starting bit index for bit selection of bits to transmit on each slot on a per-slot basis. The bit index may be an index to bits stored in the circular buffer.

### Aspects Related to Multi-Slot Uplink Transmission Occasions During Network Discontinuous Reception (DRX) Cycles

As discussed, in certain aspects, a UE is configured to transmit uplink transmissions to a network entity across multiple time periods (e.g., slots). In some cases, where the network entity is operating according to a DRX cycle configuration, at least part of an uplink transmission occasion of the UE may occur during a non-active duration of the network entity. In certain aspects, the network entity may send signaling (e.g., an RRC message, DCI, etc.) indicating the DRX cycle configuration to the UE.

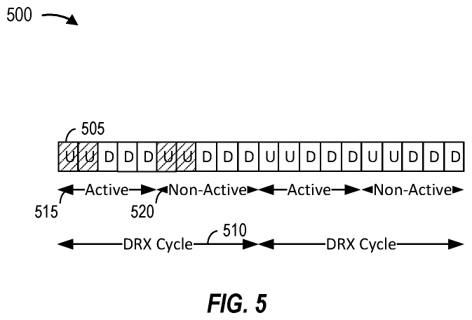

FIG. 5 illustrates an example timeline 500 where at least part of an uplink transmission occasion of a UE occurs during a non-active duration of a network entity.

Timeline 500 includes a plurality of time periods 505, which may be slots. As shown, each time period 505 is designated with a U or a D. A time period 505 designated with a U is considered an uplink-centric time period during which the UE can transmit uplink transmissions. A time period 505 designated with a D is considered a downlink-centric time period during which the UE may not transmit uplink transmissions.

FIG. 5 further shows a network entity DRX cycle 510, which as shown in this non-limiting example has a length of 10 time periods 505 and recurs every 10 time periods 505. The DRX cycle 510 includes an active duration 515 and a non-active duration 520. In the example shown, active duration 515 has a length of 5 time periods 505 and non-active duration 520 has a length of 5 time periods 505. Though the active duration 515 and the non-active duration 520 are shown as having the same length/duration, it should be understood the active duration and non-active duration of a DRX cycle need not have the same length.

As shown, four time periods 505 are shaded in and correspond to an example of a plurality of uplink transmission occasions (e.g., indicated by the network entity to the UE). As shown, two of the plurality of uplink transmission occasions occur during active duration 515, while two of the plurality of uplink transmission occasions occur during non-active duration 520.

DRX cycle 510 is shown with a time period level granularity, such as a slot level granularity. Accordingly, the active duration 515 and non-active duration 520 begin and end at the boundaries of the time periods 505, such that any given time period 505 is completely within an active duration or a non-active duration. However, it is also possible for the DRX cycle to have a sub-time period level granularity, such as a symbol level granularity. Accordingly, the active duration 515 and non-active duration 520 may begin and/or end in the middle of a time period 505, such that a given time period 505 may span both an active duration and a non-active duration. Accordingly, an uplink transmission occasion within a time period 505 may span in time both an active duration and a non-active duration such that the uplink transmission occasion partly occurs during a non-active duration. Further, an uplink transmission occasion may or may not span an entire time period 505 in time.

In timeline 500, the plurality of uplink transmission occasions all occur during a single DRX cycle. However, it should be noted that the plurality of uplink transmission occasions may occur during more than one DRX cycle, such as during more than one active duration and/or more than one non-active duration.

As discussed, aspects discussed herein describe techniques for handling the scenario where one or more uplink transmission occasions of a plurality of uplink transmission occasions at least partly occur during one or more non-active durations of the network entity, such as shown in timeline 500.

In certain aspects, when one or more uplink transmission occasions of a plurality of uplink transmission occasions at least partly occur during one or more non-active durations of the network entity, the UE refrains from transmitting in any of the plurality of uplink transmission occasions, which may be referred to as a “first behavior.” For example, in timeline 500, the UE may refrain from transmitting in all four uplink transmission occasions including the two that occur during active duration 515 and the two that occur during non-active duration 520. For example, the UE may be configured with a burst of transmission by a configured grant and drop the entire burst if any uplink transmission occasion to transmit the burst occurs during a non-active duration.

In certain aspects, when one or more uplink transmission occasions of a plurality of uplink transmission occasions at least partly occur during one or more non-active durations of the network entity, the UE still transmits in all of the plurality of uplink transmission occasions, which may be referred to as a “second behavior.” For example, in timeline 500, the UE may transmit in all four uplink transmission occasions including the two that occur during active duration 515 and the two that occur during non-active duration 520.

In certain aspects, when one or more uplink transmission occasions of a plurality of uplink transmission occasions at least partly occur during one or more non-active durations of the network entity, the UE refrains from transmitting in the one or more uplink transmission occasions, but still transmits in the other uplink transmission occasions of the plurality of uplink transmission occasions, which may be referred to as a “third behavior.” For example, in timeline 500, the UE may transmit in the two uplink transmission occasions that occur during active duration 515, but may not transmit in the two uplink transmission occasions that occur during non-active duration 520.

In certain aspects, the network entity is configured to send signaling (e.g., RRC message, DCI, etc.) indicating to the UE which behavior among the first behavior, second behavior, and third behavior to use. In certain aspects, the network entity may reconfigure at some time the UE from operating according to one behavior to operating according to another behavior.

In certain aspects, when the UE is configured with the third behavior, the UE is configured to send an indication to the network entity indicating that the UE will refrain from transmitting in the uplink transmission occasions that occur during a non-active duration (e.g., one or more non-active durations). For example, the UE sends an indication to the network entity indicating that the UE will refrain from transmitting in the uplink transmission occasions that occur during non-active duration 520. In certain aspects, the indication indicates specifically which of the plurality of uplink transmission occasions that the UE is not going to transmit. In certain aspects, the indication is transmitted by UE to the network entity in uplink control information (UCI). In certain aspects, the indication is referred to as a UCI skipping indication. For example, where the UE receives, from a network entity, a DCI with a TDRA field indicating a number of uplink transmission occasions for the UE to transmit within, and the UE transmits in less than the number of uplink transmission occasions indicated by the TDRA field, the UCI skipping indication informs the network entity that the UE is transmitting in less than the number of uplink transmission occasions indicated by the TDRA field, which may allow the network entity to sleep during such uplink transmission occasions.

In certain aspects, the UE is configured to send an indication to the network entity indicating a number of the plurality of time periods (e.g., slots) over which the UE will transmit a transport block. For example, the UE may send the indication in UCI. For example, the number of time periods over which the UE sends the transport block may be used to calculate the number of information bits sent in the transport block, and therefore the network entity is able to determine the number of information bits being transmitted in the transport block from the UE, such as to decode the transport block. In certain aspects, the number of information bits N_{info} sent in the transport block is calculated as follows:

N_{info}=N′×N_{RE}×R×Qₘ×v (1)

Wherein, N′ is the number of time periods over which the UE sends the transport block, N_{RE} is number of available resource elements within each time period for transmitting the transport block, R is the coding rate for the transport block, Qₘ is the modulation order for the transport block, and v is the number of layers over which the transport block is transmitted.

In certain aspects, for the third behavior, the indication of the number of the plurality of time periods over which the UE will transmit a transport block indicates that the UE is not transmitting in one or more uplink transmission occasions of the plurality of uplink transmission occasions (e.g., that at least partly occur during one or more non-active durations of the network entity) as the indication may be a number less than a number of the plurality of time periods allocated for the UE to transmit. In certain aspects, for the second behavior, the indication of the number of the plurality of time periods over which the UE will transmit a transport block indicates that the UE is transmitting in one or more uplink transmission occasions of the plurality of uplink transmission occasions that at least partly occur during one or more non-active durations of the network entity as the indication may be a number greater than a number of the plurality of time periods allocated for the UE to transmit that occur during one or more active durations.

In certain aspects, for the third behavior, the UE is configured to scale a transport block to the other uplink transmission occasions of the plurality of uplink transmission occasions that occur during one or more active durations. For example, in timeline 500, the UE may scale (e.g., encode) the transport block to the two uplink transmission occasions that occur during active duration 515, and transmit the transport block in the two uplink transmission occasions that occur during active duration 515. In certain aspects, where the UE is configured to send multiple repetitions (e.g., two) of the transport block on the one or more uplink transmission occasions that occur during one or more active durations, the UE is configured to transmit a first repetition and a second repetition of the single transport block over the one or more uplink transmission occasions that occur during one or more active durations, wherein the first repetition and the second repetition are transmitted over different numbers of uplink transmission occasions. For example, where the first repetition has more uplink transmission occasions that fall in one or more non-active durations than the second repetition, more uplink transmission occasions may be used to transmit the second repetition.

In certain aspects, where the UE is configured to send multiple repetitions (e.g., two) of the transport block on the one or more uplink transmission occasions that occur during one or more active durations, the UE is configured to transmit a first repetition and a second repetition of the single transport block over the one or more uplink transmission occasions that occur during one or more active durations, wherein the first repetition and the second repetition are transmitted over the same numbers of uplink transmission occasions. For example, the first repetition and second repetition may be equally allocated over the one or more uplink transmission occasions that occur during one or more active durations.

In certain aspects, such as for TBoMS, where one or more uplink transmission occasions occur during one or more non-active durations, the UE is configured to flush the circular buffer and assume a new number of time periods (corresponding to the number of time periods that occur during one or more active durations) available for TBoMS and determines a new starting bit index for each time period of the number of time periods that occur during one or more active durations.

In certain aspects, such as for TBoMS, the network entity is configured to not schedule any of the plurality of transmission occasions to occur during a non-active duration. For example, after a certain amount of time of a DRX cycle has elapsed, if during the DRX cycle the network entity sends an indication (e.g., DCI including a TDRA) of a number of time periods over which to transmit, the indication is limited to indicating a single time period (e.g., slot).

In certain aspects, where the network entity sends an indication of a plurality of uplink transmission occasions, the plurality of uplink transmission occasions to occur over a plurality of time periods, the indication comprises a plurality of bits. In certain aspects, after a certain amount of time of a DRX cycle has elapsed, meaning as the remaining active duration of the DRX cycle decreases (e.g., is less than a threshold), the network indicates, such as during the DRX cycle, a smaller number of uplink transmission occasions as a smaller number of uplink transmission occasions are available during the remaining active duration of the DRX cycle. Accordingly, a number of bits needed to indicate the smaller number of uplink transmission occasions may be reduced as compared to a number of bits needed to indicate a larger number of uplink transmission occasions. Therefore, in certain aspects, the UE can assume a value of one or more of the plurality of bits of the indication while decoding the indication based on a remaining duration of an active duration to occur after receiving the indication. For example, the UE assumes the network entity is indicating a smaller number of uplink transmission occasions, so it may assume the most significant bits of the plurality of bits are some set value(s), e.g., 0. This may provide the technical effect that decoding reliability of the indication is increased. For example, if the indication is 5-bits, and the value of 3-bits may be fixed, leaving only 2-bits that the UE needs to decode.

In certain aspects, such as for a burst of transmission configured by a configured grant, when one or more uplink transmission occasions of a plurality of uplink transmission occasions at least partly occur during one or more non-active durations of the network entity, the UE refrains from transmitting in all of the plurality of uplink transmission occasions when a number of the one or more uplink transmission occasions is greater than a threshold number n. Further, when the number of the one or more uplink transmission occasions is not greater than (e.g., is less than or equal to) the threshold number n, the UE transmits in the other uplink transmission occasions of the plurality of uplink transmission occasions. In certain aspects, the network entity sends an indication of the threshold number n to the UE, such as using RRC signaling (e.g., in a configured grant configuration). For example, in timeline 500, the UE may transmit in the two uplink transmission occasions that occur during active duration 515, but may not transmit in the two uplink transmission occasions that occur during non-active duration 520 when the threshold number is 3, as 2 is less than 3. Further, the UE may not transmit in the four uplink transmission occasions that occur during active duration 515 and non-active duration 520 when the threshold number is 1, as 2 is greater than 1.

In certain aspects, such as for a burst of transmission configured by a configured grant, when one or more uplink transmission occasions of a plurality of uplink transmission occasions at least partly occur during one or more non-active durations of the network entity, the UE transmits in any of the plurality of uplink transmission occasions that occur during an active duration. Further, the UE transmits in the one or more uplink transmission occasions that at least partly occur during one or more non-active durations when a number of the one or more uplink transmission occasions is less than a threshold number x. Further, the UE refrains from transmitting in the one or more uplink transmission occasions that at least partly occur during one or more non-active durations when the number of the one or more uplink transmission occasions is not less than (e.g., is greater than or equal to) the threshold number x. In certain aspects, the network entity sends an indication of the threshold number x to the UE, such as using RRC signaling (e.g., in a configured grant configuration). For example, in timeline 500, the UE may transmit in the two uplink transmission occasions that occur during active duration 515, and may transmit in the two uplink transmission occasions that occur during non-active duration 520 when the threshold number is 3, as 2 is less than 3. The UE may transmit in the two uplink transmission occasions that occur during active duration 515, and may not transmit in the two uplink transmission occasions that occur during non-active duration 520 when the threshold number is 1, as 2 is greater than 1.

### Example Operations

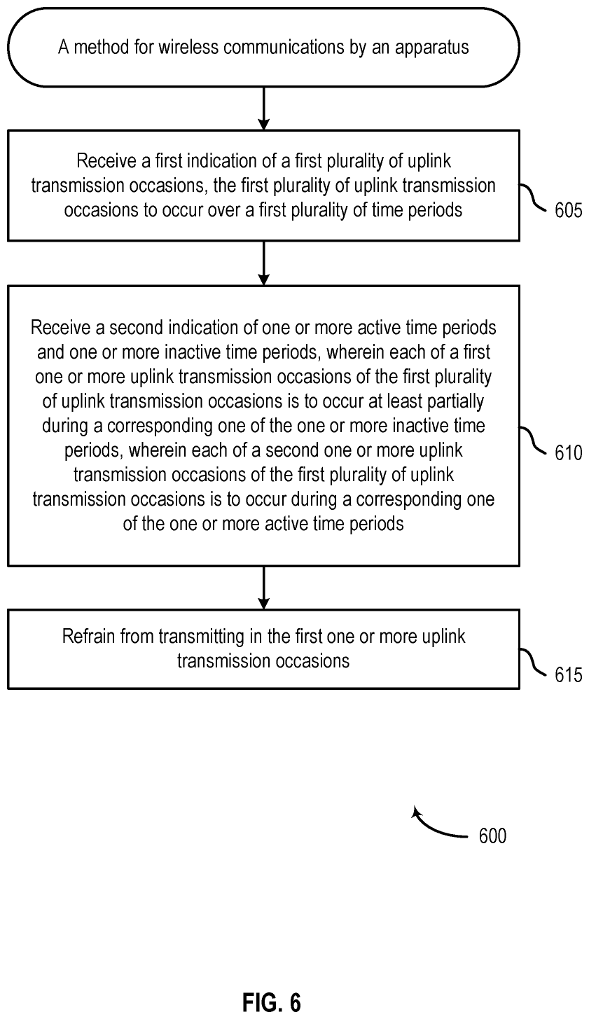

FIG. 6 shows a method 600 for wireless communications by an apparatus. In certain aspects, the apparatus is a UE, such as a UE 104 of FIGS. 1 and 3.

Method 600 begins at step 605 with receiving a first indication of a first plurality of uplink transmission occasions, the first plurality of uplink transmission occasions to occur over a first plurality of time periods.

Method 600 then proceeds to step 610 with receiving a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods.

Method 600 then proceeds to step 615 with refraining from transmitting in the first one or more uplink transmission occasions.

In certain aspects, method 600 further includes refraining from transmitting in the second one or more uplink transmission occasions.

In certain aspects, method 600 further includes transmitting in the second one or more uplink transmission occasions.

In certain aspects, method 600 further includes sending a third indication that the apparatus will refrain from transmitting in the first one or more uplink transmission occasions.

In certain aspects, transmitting in the second one or more uplink transmission occasions comprises transmitting a single transport block over the second one or more uplink transmission occasions.

In certain aspects, transmitting the single transport block comprises transmitting a first repetition and a second repetition of the single transport block over the second one or more uplink transmission occasions, wherein the first repetition and the second repetition are transmitted over different numbers of uplink transmission occasions.

In certain aspects, transmitting the single transport block comprises transmitting a first repetition and a second repetition of the single transport block over the second one or more uplink transmission occasions, wherein the first repetition and the second repetition are transmitted over a same number of uplink transmission occasions.

In certain aspects, method 600 further includes receiving a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods.

In certain aspects, method 600 further includes transmitting in the third one or more uplink transmission occasions and the fourth one or more uplink transmission occasions.

In certain aspects, method 600 further includes receiving a third indication of a configuration for handling uplink transmission occasions that are to occur at least partially during the one or more inactive time periods, wherein the configuration configures the apparatus to one of: refrain from transmitting in all uplink transmission occasions of a plurality of uplink transmission occasions when at least one of the plurality of uplink transmission occasions at least partially occurs during an inactive time period; transmit in all uplink transmission occasions of the plurality of uplink transmission occasions when at least one of the plurality of uplink transmission occasions occurs at least partially during an inactive time period; or refrain from transmitting in all uplink transmission occasions of the plurality of uplink transmission occasions that occur at least partially during inactive time periods, and transmit in all uplink transmission occasions of the plurality of uplink transmission occasions that occur during active time periods.

In certain aspects, method 600 further includes sending a third indication indicating a number of the first plurality of time periods in which the apparatus will transmit a transport block.

In certain aspects, the first indication comprises a plurality of bits, and wherein the method further comprises: assuming a value of one or more of the plurality of bits while decoding the first indication based on a remaining duration of a first active time period to occur after receiving the first indication.

In certain aspects, method 600 further includes refraining from transmitting in the second one or more uplink transmission occasions when a number of the first one or more uplink transmission occasions is greater than a threshold number.

In certain aspects, method 600 further includes transmitting in the second one or more uplink transmission occasions when the number of the first one or more uplink transmission occasions is not greater than the threshold number.

In certain aspects, method 600 further includes receiving a third indication of the threshold number.

In certain aspects, method 600 further includes receiving a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods.

In certain aspects, method 600 further includes transmitting in the fourth one or more uplink transmission occasions.

In certain aspects, method 600 further includes transmitting in the third one or more uplink transmission occasions when a number of the third one or more uplink transmission occasions is less than a threshold number.

In certain aspects, method 600 further includes refraining from transmitting in the third one or more uplink transmission occasions when a number of the third one or more uplink transmission occasions is not less than the threshold number.

In certain aspects, method 600 further includes receiving a fourth indication of the threshold number.

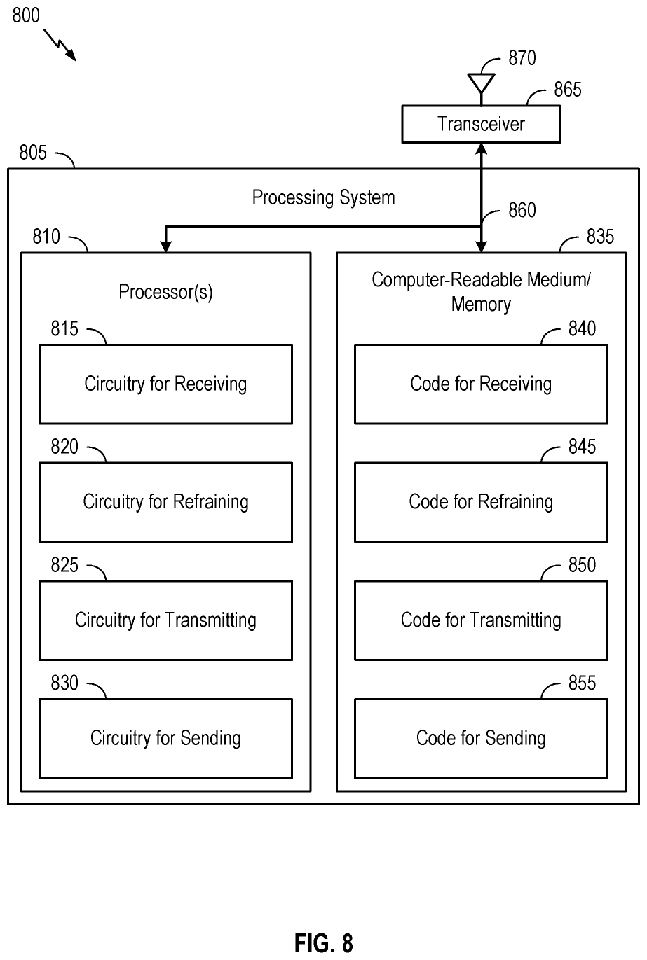

In certain aspects, method 600, or any aspect related to it, may be performed by an apparatus, such as communications device 800 of FIG. 8, which includes various components operable, configured, or adapted to perform the method 600. Communications device 800 is described below in further detail.

Note that FIG. 6 is just one example of a method, and other methods including fewer, additional, or alternative steps are possible consistent with this disclosure.

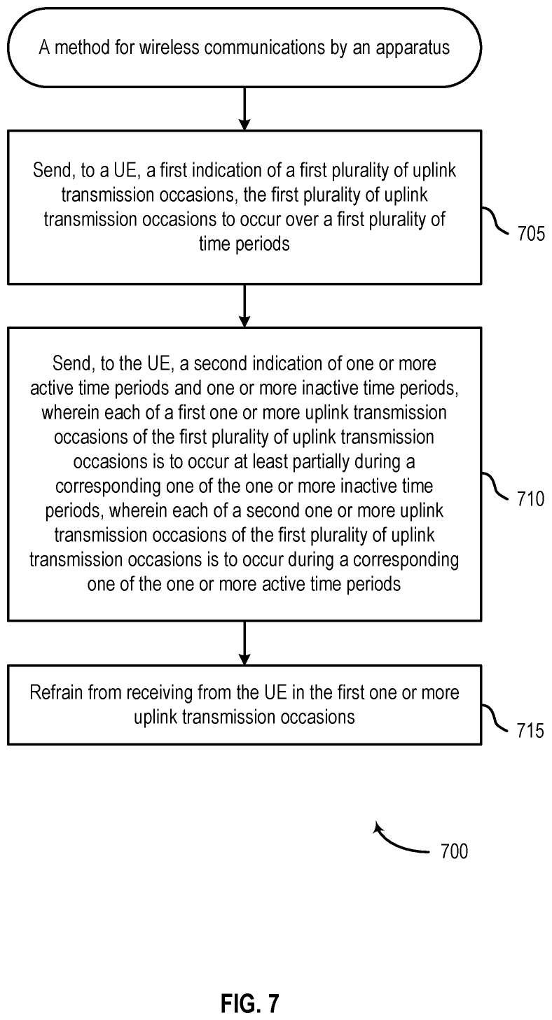

FIG. 7 shows a method 700 for wireless communications by an apparatus. In certain aspects, the apparatus is a network entity, such as a BS 102 of FIGS. 1 and 3, or a disaggregated base station as discussed with respect to FIG. 2.

Method 700 begins at step 705 with sending, to a UE, a first indication of a first plurality of uplink transmission occasions, the first plurality of uplink transmission occasions to occur over a first plurality of time periods.

Method 700 then proceeds to step 710 with sending, to the UE, a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods.

Method 700 then proceeds to step 715 with refraining from receiving from the UE in the first one or more uplink transmission occasions.

In certain aspects, method 700 further includes refraining from receiving from the UE in the second one or more uplink transmission occasions.

In certain aspects, method 700 further includes receiving in the second one or more uplink transmission occasions.

In certain aspects, method 700 further includes receiving a third indication that the UE will refrain from transmitting in the first one or more uplink transmission occasions.

In certain aspects, receiving in the second one or more uplink transmission occasions comprises receiving a single transport block over the second one or more uplink transmission occasions.

In certain aspects, receiving the single transport block comprises receiving a first repetition and a second repetition of the single transport block over the second one or more uplink transmission occasions, wherein the first repetition and the second repetition are received over different numbers of uplink transmission occasions.

In certain aspects, receiving the single transport block comprises receiving a first repetition and a second repetition of the single transport block over the second one or more uplink transmission occasions, wherein the first repetition and the second repetition are received over a same number of uplink transmission occasions.

In certain aspects, method 700 further includes transmitting a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods.

In certain aspects, method 700 further includes receiving in the third one or more uplink transmission occasions and the fourth one or more uplink transmission occasions.

In certain aspects, method 700 further includes transmitting a third indication of a configuration for handling uplink transmission occasions that are to occur at least partially during the one or more inactive time periods, wherein the configuration configures the UE to one of: refrain from transmitting in all uplink transmission occasions of a plurality of uplink transmission occasions when at least one of the plurality of uplink transmission occasions at least partially occurs during an inactive time period; transmit in all uplink transmission occasions of the plurality of uplink transmission occasions when at least one of the plurality of uplink transmission occasions occurs at least partially during an inactive time period; or refrain from transmitting in all uplink transmission occasions of the plurality of uplink transmission occasions that occur at least partially during inactive time periods, and transmit in all uplink transmission occasions of the plurality of uplink transmission occasions that occur during active time periods.

In certain aspects, method 700 further includes receiving a third indication indicating a number of the first plurality of time periods in which the UE will transmit a transport block.

In certain aspects, method 700 further includes refraining from receiving in the second one or more uplink transmission occasions when a number of the first one or more uplink transmission occasions is greater than a threshold number.

In certain aspects, method 700 further includes receiving in the second one or more uplink transmission occasions when the number of the first one or more uplink transmission occasions is not greater than the threshold number.

In certain aspects, method 700 further includes sending a third indication of the threshold number.

In certain aspects, method 700 further includes sending a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods.

In certain aspects, method 700 further includes receiving in the fourth one or more uplink transmission occasions.

In certain aspects, method 700 further includes receiving in the third one or more uplink transmission occasions when a number of the third one or more uplink transmission occasions is less than a threshold number.

In certain aspects, method 700 further includes refraining from receiving in the third one or more uplink transmission occasions when a number of the third one or more uplink transmission occasions is not less than the threshold number.

In certain aspects, method 700 further includes sending a fourth indication of the threshold number.

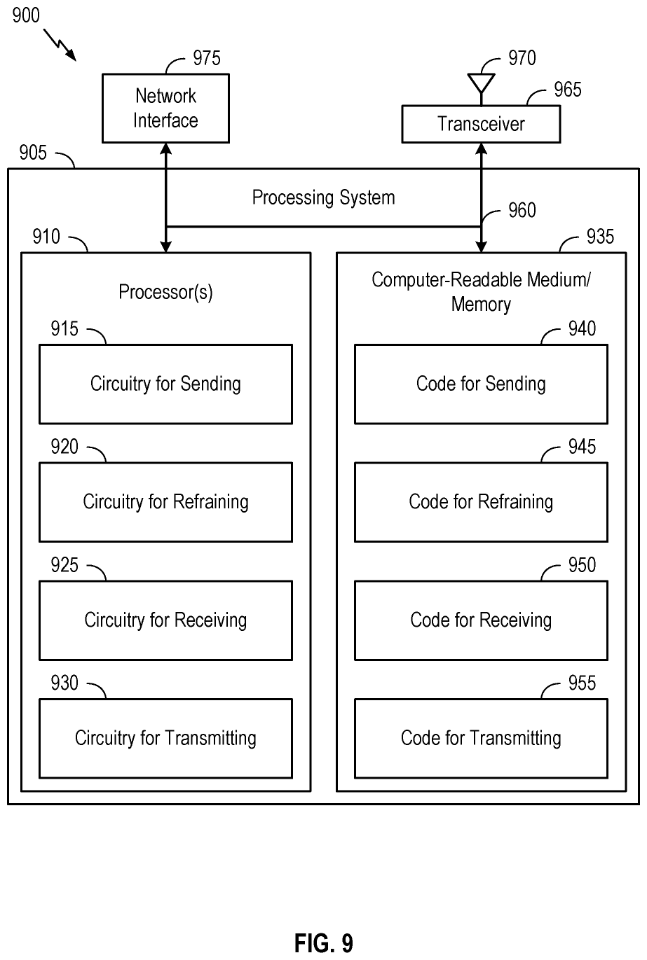

In certain aspects, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

### Example Communications Devices

FIG. 8 depicts aspects of an example communications device 800. In some aspects, communications device 800 is a user equipment, such as UE 104 described above with respect to FIGS. 1 and 3.

The communications device 800 includes a processing system 805 coupled to a transceiver 865 (e.g., a transmitter and/or a receiver). The transceiver 865 is configured to transmit and receive signals for the communications device 800 via an antenna 870, such as the various signals as described herein. The processing system 805 may be configured to perform processing functions for the communications device 800, including processing signals received and/or to be transmitted by the communications device 800.

The processing system 805 includes one or more processors 810. In various aspects, the one or more processors 810 may be representative of one or more of receive processor 358, transmit processor 364, TX MIMO processor 366, and/or controller/processor 380, as described with respect to FIG. 3. The one or more processors 810 are coupled to a computer-readable medium/memory 835 via a bus 860. In certain aspects, the computer-readable medium/memory 835 is configured to store instructions (e.g., computer-executable code) that when executed by the one or more processors 810, enable and cause the one or more processors 810 to perform the method 600 described with respect to FIG. 6, or any aspect related to it, including any additional steps or sub-steps described in relation to FIG. 6. Note that reference to a processor performing a function of communications device 800 may include one or more processors performing that function of communications device 800, such as in a distributed fashion.

In the depicted example, computer-readable medium/memory 835 stores code for receiving 840, code for refraining 845, code for transmitting 850, and code for sending 855. Processing of the code 840-855 may enable and cause the communications device 800 to perform the method 600 described with respect to FIG. 6, or any aspect related to it.

The one or more processors 810 include circuitry configured to implement (e.g., execute) the code stored in the computer-readable medium/memory 835, including circuitry for receiving 815, circuitry for refraining 820, circuitry for transmitting 825, and circuitry for sending 830. Processing with circuitry 815-830 may enable and cause the communications device 800 to perform the method 600 described with respect to FIG. 6, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 865 and/or antenna 870 of the communications device 800 in FIG. 8, and/or one or more processors 810 of the communications device 800 in FIG. 8. Means for communicating, receiving or obtaining may include the transceivers 354, antenna(s) 352, receive processor 358, and/or controller/processor 380 of the UE 104 illustrated in FIG. 3, transceiver 865 and/or antenna 870 of the communications device 800 in FIG. 8, and/or one or more processors 810 of the communications device 800 in FIG. 8.

FIG. 9 depicts aspects of an example communications device 900. In some aspects, communications device 900 is a network entity, such as BS 102 of FIGS. 1 and 3, or a disaggregated base station as discussed with respect to FIG. 2.

The communications device 900 includes a processing system 905 coupled to a transceiver 965 (e.g., a transmitter and/or a receiver) and/or a network interface 975. The transceiver 965 is configured to transmit and receive signals for the communications device 900 via an antenna 970, such as the various signals as described herein. The network interface 975 is configured to obtain and send signals for the communications device 900 via communications link(s), such as a backhaul link, midhaul link, and/or fronthaul link as described herein, such as with respect to FIG. 2. The processing system 905 may be configured to perform processing functions for the communications device 900, including processing signals received and/or to be transmitted by the communications device 900.

The processing system 905 includes one or more processors 910. In various aspects, one or more processors 910 may be representative of one or more of receive processor 338, transmit processor 320, TX MIMO processor 330, and/or controller/processor 340, as described with respect to FIG. 3. The one or more processors 910 are coupled to a computer-readable medium/memory 935 via a bus 960. In certain aspects, the computer-readable medium/memory 935 is configured to store instructions (e.g., computer-executable code) that when executed by the one or more processors 910, enable and cause the one or more processors 910 to perform the method 700 described with respect to FIG. 7, or any aspect related to it, including any additional steps or sub-steps described in relation to FIG. 7. Note that reference to a processor of communications device 900 performing a function may include one or more processors of communications device 900 performing that function, such as in a distributed fashion.

In the depicted example, the computer-readable medium/memory 935 stores code for sending 940, code for refraining 945, code for receiving 950, and code for transmitting 955. Processing of the code 940-955 may enable and cause the communications device 900 to perform the method 700 described with respect to FIG. 7, or any aspect related to it.

The one or more processors 910 include circuitry configured to implement (e.g., execute) the code stored in the computer-readable medium/memory 935, including circuitry for sending 915, circuitry for refraining 920, circuitry for receiving 925, and circuitry for transmitting 930. Processing with circuitry 915-930 may enable and cause the communications device 900 to perform the method 700 described with respect to FIG. 7, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 965 and/or antenna 970 of the communications device 900 in FIG. 9, and/or one or more processors 910 of the communications device 900 in FIG. 9. Means for communicating, receiving or obtaining may include the transceivers 332, antenna(s) 334, receive processor 338, and/or controller/processor 340 of the BS 102 illustrated in FIG. 3, transceiver 965 and/or antenna 970 of the communications device 900 in FIG. 9, and/or one or more processors 910 of the communications device 900 in FIG. 9.

### EXAMPLE CLAUSES

Implementation examples are described in the following numbered clauses:
Clause 1: A method for wireless communications by an apparatus comprising: receiving a first indication of a first plurality of uplink transmission occasions, the first plurality of uplink transmission occasions to occur over a first plurality of time periods; receiving a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and refraining from transmitting in the first one or more uplink transmission occasions.
Clause 2: The method of Clause 1, further comprising: refraining from transmitting in the second one or more uplink transmission occasions.
Clause 3: The method of Clause 1, further comprising: transmitting in the second one or more uplink transmission occasions.
Clause 4: The method of Clause 3, further comprising: sending a third indication that the apparatus will refrain from transmitting in the first one or more uplink transmission occasions.
Clause 5: The method of Clause 3, wherein transmitting in the second one or more uplink transmission occasions comprises transmitting a single transport block over the second one or more uplink transmission occasions.
Clause 6: The method of Clause 5, wherein transmitting the single transport block comprises transmitting a first repetition and a second repetition of the single transport block over the second one or more uplink transmission occasions, wherein the first repetition and the second repetition are transmitted over different numbers of uplink transmission occasions.
Clause 7: The method of Clause 5, wherein transmitting the single transport block comprises transmitting a first repetition and a second repetition of the single transport block over the second one or more uplink transmission occasions, wherein the first repetition and the second repetition are transmitted over a same number of uplink transmission occasions.
Clause 8: The method of any one of Clauses 1-7, further comprising: receiving a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods; and transmitting in the third one or more uplink transmission occasions and the fourth one or more uplink transmission occasions.
Clause 9: The method of any one of Clauses 1-8, further comprising: receiving a third indication of a configuration for handling uplink transmission occasions that are to occur at least partially during the one or more inactive time periods, wherein the configuration configures the apparatus to one of: refrain from transmitting in all uplink transmission occasions of a plurality of uplink transmission occasions when at least one of the plurality of uplink transmission occasions at least partially occurs during an inactive time period; transmit in all uplink transmission occasions of the plurality of uplink transmission occasions when at least one of the plurality of uplink transmission occasions occurs at least partially during an inactive time period; or refrain from transmitting in all uplink transmission occasions of the plurality of uplink transmission occasions that occur at least partially during inactive time periods, and transmit in all uplink transmission occasions of the plurality of uplink transmission occasions that occur during active time periods.
Clause 10: The method of any one of Clauses 1-9, further comprising: sending a third indication indicating a number of the first plurality of time periods in which the apparatus will transmit a transport block.
Clause 11: The method of any one of Clauses 1-10, wherein the first indication comprises a plurality of bits, and wherein the method further comprises: assuming a value of one or more of the plurality of bits while decoding the first indication based on a remaining duration of a first active time period to occur after receiving the first indication.
Clause 12: The method of any one of Clauses 1 or 9-11, further comprising: refraining from transmitting in the second one or more uplink transmission occasions when a number of the first one or more uplink transmission occasions is greater than a threshold number; and transmitting in the second one or more uplink transmission occasions when the number of the first one or more uplink transmission occasions is not greater than the threshold number.
Clause 13: The method of Clause 12, further comprising: receiving a third indication of the threshold number.
Clause 14: The method of any one of Clauses 1 or 9-11, further comprising: receiving a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods; transmitting in the fourth one or more uplink transmission occasions; transmitting in the third one or more uplink transmission occasions when a number of the third one or more uplink transmission occasions is less than a threshold number; and refraining from transmitting in the third one or more uplink transmission occasions when a number of the third one or more uplink transmission occasions is not less than the threshold number.
Clause 15: The method of Clause 14, further comprising: receiving a fourth indication of the threshold number.
Clause 16: A method for wireless communications by an apparatus comprising: sending, to a UE, a first indication of a first plurality of uplink transmission occasions, the first plurality of uplink transmission occasions to occur over a first plurality of time periods; sending, to the UE, a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and refraining from receiving from the UE in the first one or more uplink transmission occasions.
Clause 17: The method of Clause 16, further comprising: refraining from receiving from the UE in the second one or more uplink transmission occasions.
Clause 18: The method of Clause 16, further comprising: receiving in the second one or more uplink transmission occasions.
Clause 19: The method of Clause 18, further comprising: receiving a third indication that the UE will refrain from transmitting in the first one or more uplink transmission occasions.
Clause 20: The method of Clause 18, wherein receiving in the second one or more uplink transmission occasions comprises receiving a single transport block over the second one or more uplink transmission occasions.
Clause 21: The method of Clause 20, wherein receiving the single transport block comprises receiving a first repetition and a second repetition of the single transport block over the second one or more uplink transmission occasions, wherein the first repetition and the second repetition are received over different numbers of uplink transmission occasions.
Clause 22: The method of Clause 20, wherein receiving the single transport block comprises receiving a first repetition and a second repetition of the single transport block over the second one or more uplink transmission occasions, wherein the first repetition and the second repetition are received over a same number of uplink transmission occasions.
Clause 23: The method of any one of Clauses 16-22, further comprising: transmitting a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods; and receiving in the third one or more uplink transmission occasions and the fourth one or more uplink transmission occasions.
Clause 24: The method of any one of Clauses 16-23, further comprising: transmitting a third indication of a configuration for handling uplink transmission occasions that are to occur at least partially during the one or more inactive time periods, wherein the configuration configures the UE to one of: refrain from transmitting in all uplink transmission occasions of a plurality of uplink transmission occasions when at least one of the plurality of uplink transmission occasions at least partially occurs during an inactive time period; transmit in all uplink transmission occasions of the plurality of uplink transmission occasions when at least one of the plurality of uplink transmission occasions occurs at least partially during an inactive time period; or refrain from transmitting in all uplink transmission occasions of the plurality of uplink transmission occasions that occur at least partially during inactive time periods, and transmit in all uplink transmission occasions of the plurality of uplink transmission occasions that occur during active time periods.
Clause 25: The method of any one of Clauses 16-24, further comprising: receiving a third indication indicating a number of the first plurality of time periods in which the UE will transmit a transport block.
Clause 26: The method of any one of Clauses 16 or 23-25, further comprising: refraining from receiving in the second one or more uplink transmission occasions when a number of the first one or more uplink transmission occasions is greater than a threshold number; and receiving in the second one or more uplink transmission occasions when the number of the first one or more uplink transmission occasions is not greater than the threshold number.
Clause 27: The method of Clause 26, further comprising: sending a third indication of the threshold number.
Clause 28: The method of any one of Clauses 16 or 23-25, further comprising: sending a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods; receiving in the fourth one or more uplink transmission occasions; receiving in the third one or more uplink transmission occasions when a number of the third one or more uplink transmission occasions is less than a threshold number; and refraining from receiving in the third one or more uplink transmission occasions when a number of the third one or more uplink transmission occasions is not less than the threshold number.
Clause 29: The method of Clause 28, further comprising: sending a fourth indication of the threshold number.
Clause 30: One or more apparatuses, comprising: one or more memories comprising executable instructions; and one or more processors configured to execute the executable instructions and cause the one or more apparatuses to perform a method in accordance with any one of clauses 1-29.
Clause 31: One or more apparatuses, comprising means for performing a method in accordance with any one of clauses 1-29.
Clause 32: One or more non-transitory computer-readable media comprising executable instructions that, when executed by one or more processors of one or more apparatuses, cause the one or more apparatuses to perform a method in accordance with any one of clauses 1-29.
Clause 33: One or more computer program products embodied on one or more computer-readable storage media comprising code for performing a method in accordance with any one of clauses 1-29.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: one or more memories comprising processor-executable instructions; and one or more processors configured to execute the processor-executable instructions and cause the apparatus to:
receive a first indication of a first plurality of uplink transmission occasions, the first plurality of uplink transmission occasions to occur over a first plurality of time periods;
receive a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and
refrain from transmitting in the first one or more uplink transmission occasions.

2. The apparatus of claim 1, wherein the one or more processors are configured to execute the processor-executable instructions and further cause the apparatus to:
refrain from transmitting in the second one or more uplink transmission occasions.

3. The apparatus of claim 1, wherein the one or more processors are configured to execute the processor-executable instructions and further cause the apparatus to:
transmit in the second one or more uplink transmission occasions.

4. The apparatus of claim 3, wherein the one or more processors are configured to execute the processor-executable instructions and further cause the apparatus to:
send a third indication that the apparatus will refrain from transmitting in the first one or more uplink transmission occasions.

5. The apparatus of claim 3, wherein, to transmit in the second one or more uplink transmission occasions, the one or more processors are configured to execute the processor-executable instructions and cause the apparatus to transmit a single transport block over the second one or more uplink transmission occasions.

6. The apparatus of claim 5, wherein to transmit the single transport block, the one or more processors are configured to execute the processor-executable instructions and cause the apparatus to:
transmit a first repetition and a second repetition of the single transport block over the second one or more uplink transmission occasions, wherein the first repetition and the second repetition are transmitted over different numbers of uplink transmission occasions.

7. The apparatus of claim 5, wherein to transmit the single transport block, the one or more processors are configured to execute the processor-executable instructions and cause the apparatus to:
transmit a first repetition and a second repetition of the single transport block over the second one or more uplink transmission occasions, wherein the first repetition and the second repetition are transmitted over a same number of uplink transmission occasions.

8. The apparatus of claim 1, wherein the one or more processors are configured to execute the processor-executable instructions and further cause the apparatus to:
receive a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods; and
transmit in the third one or more uplink transmission occasions and the fourth one or more uplink transmission occasions.

9. The apparatus of claim 1, wherein the one or more processors are configured to execute the processor-executable instructions and further cause the apparatus to:
receive a third indication of a configuration for handling uplink transmission occasions that are to occur at least partially during the one or more inactive time periods, wherein the configuration configures the apparatus to one of:
refrain from transmitting in all uplink transmission occasions of a plurality of uplink transmission occasions when at least one of the plurality of uplink transmission occasions at least partially occurs during an inactive time period;
transmit in all uplink transmission occasions of the plurality of uplink transmission occasions when at least one of the plurality of uplink transmission occasions occurs at least partially during an inactive time period; or
refrain from transmitting in all uplink transmission occasions of the plurality of uplink transmission occasions that occur at least partially during inactive time periods, and transmit in all uplink transmission occasions of the plurality of uplink transmission occasions that occur during active time periods.

10. The apparatus of claim 1, wherein the one or more processors are configured to execute the processor-executable instructions and further cause the apparatus to:
send a third indication indicating a number of the first plurality of time periods in which the apparatus will transmit a transport block.

11. The apparatus of claim 1, wherein the first indication comprises a plurality of bits, and wherein the one or more processors are configured to execute the processor-executable instructions and further cause the apparatus to:
assume a value of one or more of the plurality of bits while decoding the first indication based on a remaining duration of a first active time period to occur after receiving the first indication.

12. The apparatus of claim 1, wherein the one or more processors are configured to execute the processor-executable instructions and further cause the apparatus to:
refrain from transmitting in the second one or more uplink transmission occasions when a number of the first one or more uplink transmission occasions is greater than a threshold number; and
transmit in the second one or more uplink transmission occasions when the number of the first one or more uplink transmission occasions is not greater than the threshold number.

13. The apparatus of claim 1, wherein the one or more processors are configured to execute the processor-executable instructions and further cause the apparatus to:
receive a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods;
transmit in the fourth one or more uplink transmission occasions;
transmit in the third one or more uplink transmission occasions when a number of the third one or more uplink transmission occasions is less than a threshold number; and
refrain from transmitting in the third one or more uplink transmission occasions when a number of the third one or more uplink transmission occasions is not less than the threshold number.

14. An apparatus configured for wireless communications, comprising: one or more memories comprising processor-executable instructions; and one or more processors configured to execute the processor-executable instructions and cause the apparatus to:
send, to a user equipment (UE), a first indication of a first plurality of uplink transmission occasions, the first plurality of uplink transmission occasions to occur over a first plurality of time periods;
send, to the UE, a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and
refrain from receiving from the UE in the first one or more uplink transmission occasions.

15. The apparatus of claim 14, wherein the one or more processors are configured to execute the processor-executable instructions and further cause the apparatus to:
refrain from receiving from the UE in the second one or more uplink transmission occasions.

16. The apparatus of claim 14, wherein the one or more processors are configured to execute the processor-executable instructions and further cause the apparatus to:
receive in the second one or more uplink transmission occasions.

17. The apparatus of claim 16, wherein the one or more processors are configured to execute the processor-executable instructions and further cause the apparatus to:
receive a third indication that the UE will refrain from transmitting in the first one or more uplink transmission occasions.

18. The apparatus of claim 16, wherein, to receive in the second one or more uplink transmission occasions, the one or more processors are configured to execute the processor-executable instructions and cause the apparatus to receive a single transport block over the second one or more uplink transmission occasions.

19. The apparatus of claim 18, wherein to receive the single transport block, the one or more processors are configured to execute the processor-executable instructions and cause the apparatus to:
receive a first repetition and a second repetition of the single transport block over the second one or more uplink transmission occasions, wherein the first repetition and the second repetition are received over different numbers of uplink transmission occasions.

20. The apparatus of claim 18, wherein to receive the single transport block, the one or more processors are configured to execute the processor-executable instructions and cause the apparatus to:
receive a first repetition and a second repetition of the single transport block over the second one or more uplink transmission occasions, wherein the first repetition and the second repetition are received over a same number of uplink transmission occasions.

21. The apparatus of claim 14, wherein the one or more processors are configured to execute the processor-executable instructions and further cause the apparatus to:
transmit a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods; and
receive in the third one or more uplink transmission occasions and the fourth one or more uplink transmission occasions.

22. The apparatus of claim 14, wherein the one or more processors are configured to execute the processor-executable instructions and further cause the apparatus to:
transmit a third indication of a configuration for handling uplink transmission occasions that are to occur at least partially during the one or more inactive time periods, wherein the configuration configures the UE to one of:
refrain from transmitting in all uplink transmission occasions of a plurality of uplink transmission occasions when at least one of the plurality of uplink transmission occasions at least partially occurs during an inactive time period;
transmit in all uplink transmission occasions of the plurality of uplink transmission occasions when at least one of the plurality of uplink transmission occasions occurs at least partially during an inactive time period; or
refrain from transmitting in all uplink transmission occasions of the plurality of uplink transmission occasions that occur at least partially during inactive time periods, and transmit in all uplink transmission occasions of the plurality of uplink transmission occasions that occur during active time periods.

23. The apparatus of claim 14, wherein the one or more processors are configured to execute the processor-executable instructions and further cause the apparatus to:
receive a third indication indicating a number of the first plurality of time periods in which the UE will transmit a transport block.

24. The apparatus of claim 14, wherein the one or more processors are configured to execute the processor-executable instructions and further cause the apparatus to:
refrain from receiving in the second one or more uplink transmission occasions when a number of the first one or more uplink transmission occasions is greater than a threshold number; and
receive in the second one or more uplink transmission occasions when the number of the first one or more uplink transmission occasions is not greater than the threshold number.

25. The apparatus of claim 1, wherein the one or more processors are configured to execute the processor-executable instructions and further cause the apparatus to:
send a third indication of a second plurality of uplink transmission occasions, the second plurality of uplink transmission occasions to occur over a second plurality of time periods, wherein each of a third one or more uplink transmission occasions of the second plurality of uplink transmission occasions is to occur at least partially during a corresponding one of the one or more inactive time periods, and wherein each of a fourth one or more uplink transmission occasions of the second plurality of uplink transmission occasions is to occur during a corresponding one of the one or more active time periods;
receive in the fourth one or more uplink transmission occasions;
receive in the third one or more uplink transmission occasions when a number of the third one or more uplink transmission occasions is less than a threshold number; and
refrain from receiving in the third one or more uplink transmission occasions when a number of the third one or more uplink transmission occasions is not less than the threshold number.

26. A method for wireless communications by an apparatus comprising:
receiving a first indication of a first plurality of uplink transmission occasions, the first plurality of uplink transmission occasions to occur over a first plurality of time periods;
receiving a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and
refraining from transmitting in the first one or more uplink transmission occasions.

27. The method of claim 26, further comprising:
refraining from transmitting in the second one or more uplink transmission occasions.

28. The method of claim 26, further comprising:
transmitting in the second one or more uplink transmission occasions.

29. A method for wireless communications by an apparatus comprising:
sending, to a UE, a first indication of a first plurality of uplink transmission occasions, the first plurality of uplink transmission occasions to occur over a first plurality of time periods;
sending, to the UE, a second indication of one or more active time periods and one or more inactive time periods, wherein each of a first one or more uplink transmission occasions of the first plurality of uplink transmission occasions is to occur at least partially during a corresponding one of the one or more inactive time periods, wherein each of a second one or more uplink transmission occasions of the first plurality of uplink transmission occasions is to occur during a corresponding one of the one or more active time periods; and
refraining from receiving from the UE in the first one or more uplink transmission occasions.

30. The method of claim 29, further comprising:
receiving in the second one or more uplink transmission occasions.
